(19) United States
(12) Patent Application Publication
(10) Pub. No.: US 2017/0372276 A1
(43) Pub. Date: Dec. 28, 2017

(54) Virtual Currency Conversion Device, Method and Computer Program

(71) Applicant: Masahiro TAKASAKI, Tokyo (JP)

(72) Inventor: Yoshikazu TAKASAKI, Tokyo (JP)

(21) Appl. No.: 15/540,473

(22) PCT Filed: Dec. 25, 2015
(86) PCT No.: PCT/JP2015/086377

§ 371 Date: Jun. 28, 2017

(30) Foreign Application Priority Data
Dec. 29, 2014 (JP) 2014-267089

(51) Int. Cl. G06Q 20/06; G06Q 10/06; G06Q 20/08; G06Q 20/10

(52) U.S. Cl. CPC G06Q 20/06; G06Q 20/10; G06Q 10/06; G06Q 20/085

(57) ABSTRACT

[Problem] To enable wages to be easily received in cash, virtual currency, or points, even by workers who do not have a bank account, by using systems of financial institutions, virtual currency business operators and point business operators, and to enable the same-day payment and advance payment of wages without changing the operations currently in use, even if a company uses a periodic wage payment system.

[Solution] A device that is: configured so as to be capable of communicating with a payment terminal of a currency/point business operator; possessed by an independent third party from a wage payment source, such as a company and from a worker; and used to pay a wage from the payment source to the worker as compensation for work, wherein the device comprises personal information storage means, wage information storage means, balance storage means, and conversion means for receiving a conversion request from the worker, determining whether the personal information stored in the personal information storage means matches the worker making the conversion request, and, when the monetary value of the conversion request is determined to be within the balance stored in the balance storage means, communicating authorization of wage payment.

### TECHNICAL FIELD

The present invention relates to technology that converts compensation for work to cash, points, or virtual currency via a system operated by a third party, and makes it possible for a worker to receive and use the cash, points, or virtual currency.

### BACKGROUND ART

Many people live a hand-to-mouth existence, including workers in developing countries, immigrants who work in developed countries, workers suffering from poverty, and homeless workers, and they are constantly searching a place to work on a daily basis as means to earn living expenses.

Although companies that employ these workers are looking into an implementation of paying workers cash daily, companies are likely to pay weekly or monthly due to high costs and risks. In fact, in developed countries, most wages/salaries are paid by bank transfer. Even though consideration of the risk of robbery or theft is unavoidable, many vulnerable workers still seek a small number of work sites that provide daily cash payments. However, some employers who provide daily cash payments exploit cheap labour from vulnerable workers who are made to do heavy lifting in hazardous environments.

Whereas, in many developed countries, wages are often time paid periodically and paid by bank transfer.

There are also an increasing variety of payment methods for business transactions, such as bank transfer, check, credit card, virtual currency, and point exchange.

However, workers who do not have a bank account or credit card have to give priority to find jobs that pay cash.

Also, even in developed countries, the income difference has widened. The number of people falling into poverty has been increasing, and once fallen into poverty, it is difficult to get out of it. Such a poverty cycle and economic hardship due to poverty is also linked to a rise in crime and terrorism. Periodic wage payment and paying by bank transfer are one of the factors of causing this kind of problem.

On the other hand, many companies that hesitate to pay cash daily are in need of manpower.

In light of this situation, various systems have been proposed such as those noted in the Patent Documents below.

### PRIOR ART DOCUMENTS

### Patent Documents

[Patent Document 1] Japanese Laid-Open Patent Application 2009-151553

[Patent Document 2] Japanese Laid-Open Patent Application H11-065443

[Patent Document 3] Japanese Laid-Open Patent Application 2003-233717

[Patent Document 4] Japanese Laid-Open Patent Application 2001-273389

[Patent Document 5] Japanese Laid-Open Patent Application 2005-122666

### DISCLOSURE OF THE INVENTION

### Problems the Invention is Intended to Solve

Though workers in developing countries or workers who are suffering from poverty need money to survive each day, and though compensation for work has conventionally been payment in kind or payment by cash, provided there is a method by which clothing, food, and housing can be purchased or borrowed, the compensation for work does not have to be in cash. Specifically, virtual currency that allows purchasing of food or points that can be exchanged for food are also acceptable. However, because of regulations, accounting, and convenience, wages, which are compensation for work, are currently paid by cash or bank transfer.

Inasmuch, the present invention provides a scheme for entering as a third party between a worker who demands daily cash payment or immediate cash payment and a business that wishes to pay periodically and pay by bank transfer, in order to fulfill the wishes of both parties at the same time.

### Means for Solving the Aforementioned Problems

A virtual currency conversion device according to one aspect of the present invention is a device configured so as to be capable of communicating with a payment terminal of a virtual currency/point business operator, possessed by a third party independent from a wage payment source, such as a company, and from a worker, and used for paying a wage from the wage payment source to the workers as compensation for work, wherein the virtual currency conversion device is characterized in comprising: personal information storage means for storing personal information of the workers; wage information storage means for storing the amount of wages paid to the workers and approved by the wage payment source; balance storage means for recording the balance of the wage payment amount that can be converted to virtual currency or points; and conversion means for receiving a request from the workers to convert a specified monetary value of the wage payment amount to virtual currency or points, determining whether the personal information stored in the personal information storage means matches the worker who makes the conversion request, and determining whether the specified monetary value for which the conversion request was received is within the balance stored in the balance storage means, and, when both conditions match, communicating that authorization is granted for wage payment to the payment terminal of the virtual currency/point business operator.

It is also possible to have a device for which the wage payment amount of those among the workers who do not have a bank account is temporarily transferred from a bank account of the company to a bank account of a virtual currency conversion device operator or a bank account specified by the virtual currency conversion device operator, and cash will be paid from the bank account to which the wage payment amount was transferred, the cash is being paid via a payment system of a financial institution in response to a payment request made by the worker.

It is also possible to have a device for which a connection can be established with a plurality of payment source terminals; wage information to the worker from the plurality of payment sources is stored in the wage information storage means; and the conversion means pays the wages from any of the payment sources by communicating authorization of wage payment to the payment terminals of the virtual currency/point business operators.

It is also possible to have a device for which the conversion means aggregates wages from the plurality of payment sources, and pays the wages by communicating authorization of wage payment to the payment terminals of the virtual currency/point business operators.

It is also possible to have a device for which the balance stored in the balance storage means corresponds to the balance for the wages from the payment source previously kept by the operator of the virtual currency conversion device.

It is also possible to have a device for which information on the attendance of the worker and periodic wage payment information calculated based on the attendance records are stored in the wage information storage means; and the balance stored in the balance storage means corresponds to the balance for which the operator of the virtual currency conversion device has made an advance for the amount of wages to be paid to the worker by the payment source according to the periodic wage payment information.

It is also possible to have a device for which the wage information is the wages that are accrued in each working day.

A virtual currency conversion method according to one aspect of the present invention is a method performed by a computer that is: configured so as to be capable of communicating with a payment terminal of a virtual currency/point business operator; possessed by a third party independent from a wage payment source, such as a company, and from a worker; and, in order for wages to be paid from the payment source to the worker as compensation for work, provided with: personal information storage means for storing personal information of the worker; wage information storage means for storing the amount of wages paid to the worker and approved by the payment source; and balance storage means for recording the balance of the wage payment amount that can be converted to virtual currency or points; wherein the method is characterized in comprising: a process for receiving a request from the worker to convert a specified monetary value of the wage payment amount to virtual currency or points; a process for determining whether the personal information stored in the personal information storage means matches the worker who makes the conversion request; a process for determining whether the specified monetary value for which the conversion request that was received is within the balance stored in the balance storage means; and a process for communicating authorization for wage payment to the payment terminal of the virtual currency/point business operator when both conditions are met.

A computer program according to one aspect of the present invention is a computer program executed using a computer that is: configured so as to be capable of communicating with a payment terminal of a virtual currency/point business operator; possessed by a third party independent from a wage payment source, such as a company, and from a worker; and, in order for wages to be paid from the payment source to the worker as compensation for work, provided with: personal information storage means for storing personal information of a worker; wage information storage means for storing the amount of a wage paid to the worker and approved by the payment source; and balance storage means for recording the balance of the wage payment amount that can be converted to virtual currency or points; wherein the computer program executes: a process for receiving a request from the worker to convert a specified monetary value of the wage payment amount to virtual currency or points; a process for determining whether the personal information stored in the personal information storage means matches the worker who makes the conversion request; a process for determining whether the specified monetary value for which the conversion request was received is within the balance stored in the balance storage means; and a process for communicating authorization for wage payment to the payment terminal of the virtual currency/point business operator when both conditions are met.

### Effect of the Invention

Using the present invention, even workers who do not have a bank account are able to immediately receive compensation for work, and at the same time workers are able to convert their compensation to virtual currency or points that can be exchanged for and used as the purchasing or borrowing cost for clothing, food, and housing.

### BRIEF DESCRIPTION OF THE DRAWINGS

FIG. 1 is a schematic diagram of the overall system of an embodiment of the present invention.

FIG. 2 is a functional block diagram of the embodiment.

FIG. 3 shows the process flow of the first embodiment.

FIG. 4 shows the process flow of the first embodiment.

FIG. 5 shows the process flow of the second embodiment.

FIG. 6 shows the process flow when a worker terminal is present.

### BEST MODE FOR CARRYING OUT THE INVENTION

Embodiments of the present invention are described with reference to the drawings.

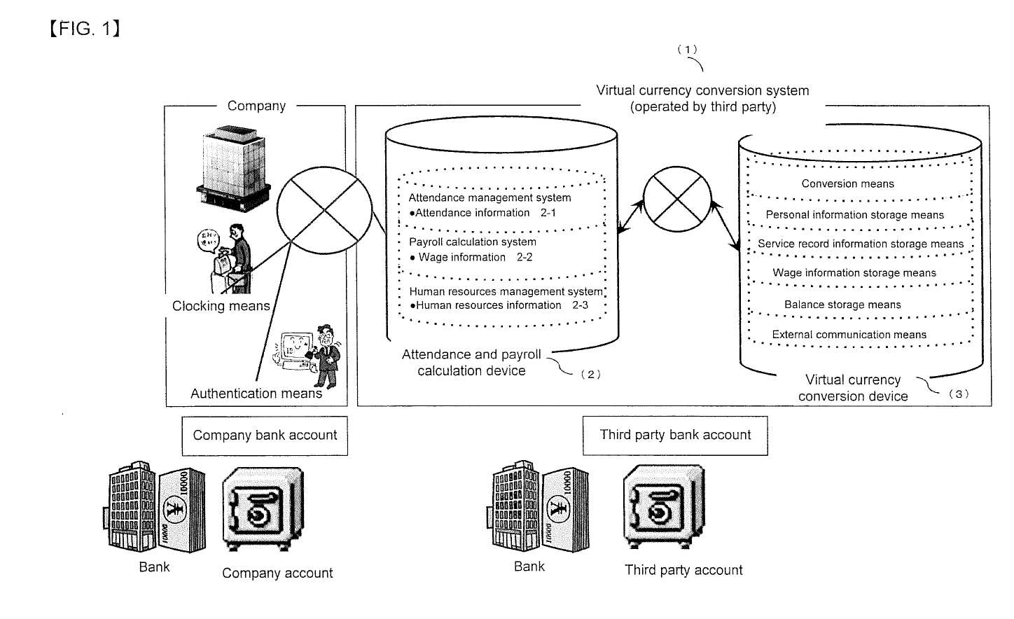

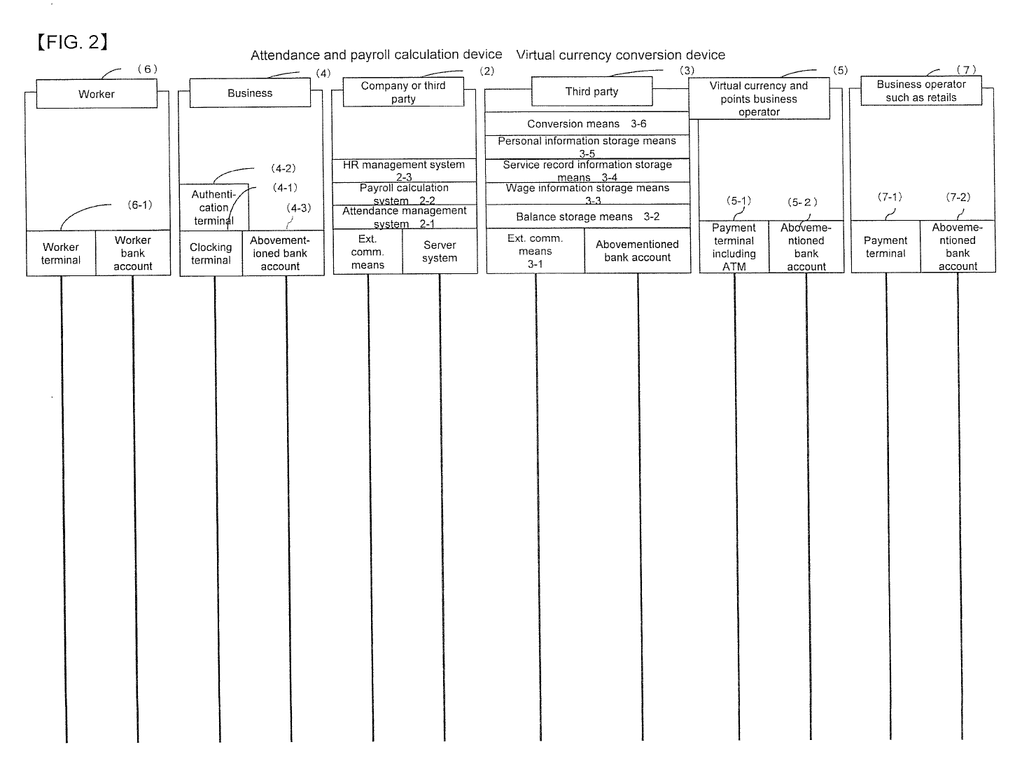

In FIG. 1 and FIG. 2, a virtual currency conversion system (1) with attendance and payroll calculation operated by a third party independent from a worker and a business employing the worker (hereafter called the “third party”) has an attendance and payroll calculation device (2) and a virtual currency conversion device (3) connected to each other via a network. Also, the virtual currency conversion system (1) is configured to be capable of communicating with a business terminal that is a wage payment source.

The virtual currency conversion system (1) is a computer system for converting all or a portion of the wages paid to a worker to virtual currency or points.

The attendance and payroll calculation device (2) is a computer for performing payroll calculation by tabulating attendance and clock-in and clock-out records, and is configured to be capable of communicating with a clocking terminal of the company via a network such as the internet.

This attendance and payroll calculation device (2) may be held by the company or the third party.

In FIG. 2, a clocking terminal (4-1) should be a computer device prepared by the company, the device being capable of communication via a network, such as a “personal computer terminal,” a cellphone terminal, a personal digital assistant (PDA), and a wearable terminal, configured to be capable of connecting to the Internet or the like.

The workers clock in and clock out through a clocking terminal (4-1) at their work sites to record work start time, task start time, work end time, and task end time. The clocking records are transmitted to an attendance management system (2-1) via a network such as the internet, and the working time of the worker is tabulated based on the clocking records.

The payroll calculation system (2-2) performs payroll calculation based on the working time tabulated by the attendance management system (2-1), and the payment amount actually paid to the worker is calculated by subtracting deductions such as taxes, annuity insurance. The calculated payment amount is saved in wage information storage means (3-3) of the virtual currency conversion device (3).

When a worker receives wages from a plurality of companies, such as when performing duties at a number of companies, the respective wage information is stored in this wage information storage means (3-3).

The balance of the wage converted to virtual currency or the like is stored in balance storage means (3-2). This balance is the monetary value that can be received as wage by the worker, the monetary value already paid as the wage amount to the third party by the company, or the amount equivalent to that paid in advance by the third party, though yet to be paid from the company to the third party, and in all cases is the monetary value that can be drawn as wage by the worker. Also, this monetary value can be a monetary value for which the balances for a plurality of wages are added together when there is a plurality of wages such as when the worker serves at a plurality of companies.

Personal information specified by the worker (e.g., account ID, name, date of birth) are saved in personal information storage means (3-5) of the virtual currency conversion device (3) from a human resources management system (2-3) of the attendance and payroll calculation device (2).

Also, work record information including information about work site at which the service occurred, clocking time, work content and the like is saved in a work record information storage means (3-4) of the virtual currency conversion device (3) from the attendance management system (2-1) of the attendance and payroll calculation device (2).

### Process Flow of Embodiment 1

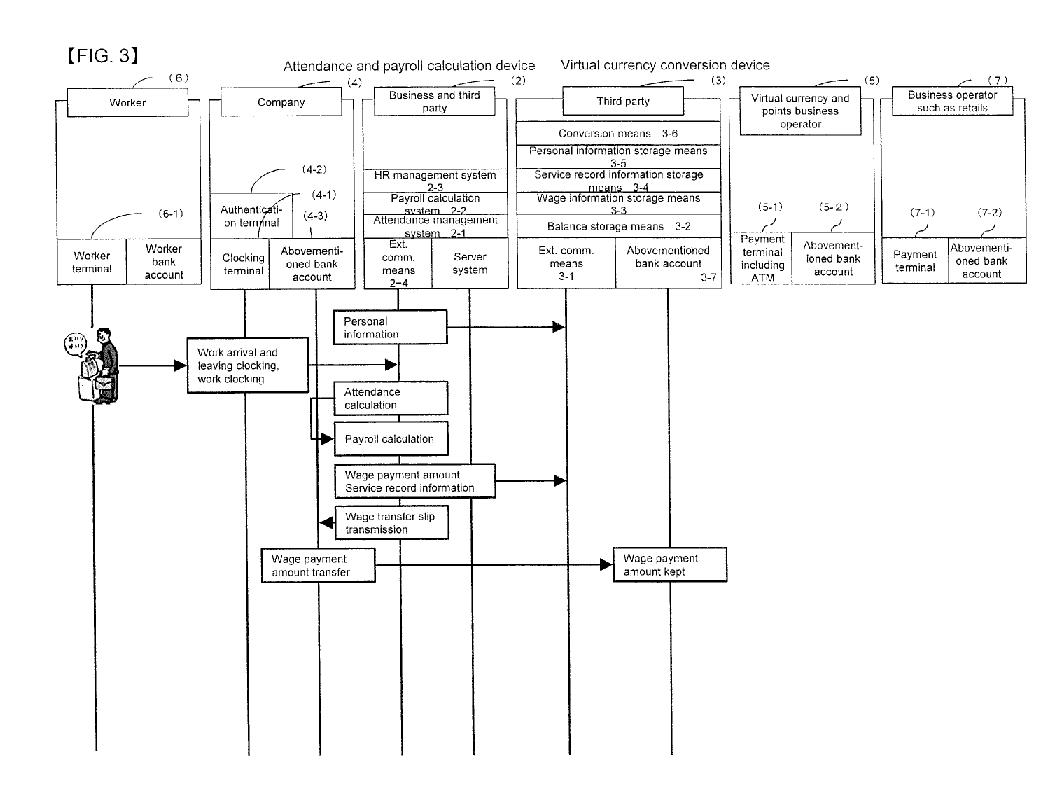

In FIG. 3, the personal information of the worker is registered in advance in the virtual currency conversion device (3) by the company or the worker.

In this state, time of clock-in and clock-out of the worker, work shifts and the like are clocked in through a business terminal (4), and that information is communicated to the attendance and payroll calculation device (2). With the attendance and payroll calculation device (2), attendance is tabulated at set intervals such as daily, weekly, or monthly, and the wages are calculated. Also, the attendance and payroll calculation device (2) communicates that attendance record information to the virtual currency conversion device (3).

The amount of wages is set by the approval of a human resources administrator of the company, and when the approval of wage transfer is transmitted from the business terminal, in regards to information for which approval was obtained to the effect that it is acceptable to transfer the wage payment amount from a bank account of the company (4-3) to a bank account of the third party (3-7), the attendance and payroll calculation device (2) creates wage transfer slip information and transmits this information to the applicable paying bank. Using the bank system, the wage payment amount is transferred from the bank account of the company (4-3) to the bank account of the third party (3-7), and this amount is stored in the balance storage means (3-2) as the wage payment amount kept by the third party.

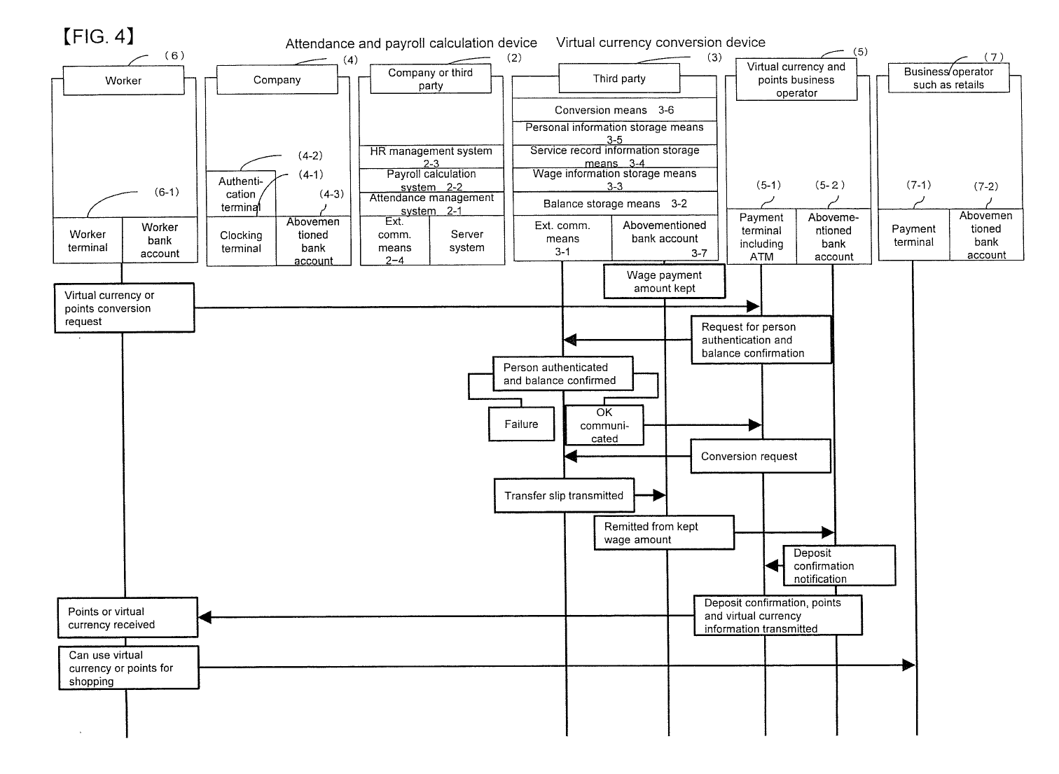

In FIG. 4, when the third party keeps the wage payment amount on behalf of the worker with the process described previously, the worker makes a request to a virtual currency/point business operator (5) using a payment terminal (5-1) of the virtual currency/point business operator (5) for payment or for conversion to virtual currency or points of a specified monetary value of the wage payment amount. The operation can be carried out by the worker, or can be performed by a representative.

The virtual currency/point business operator (5) performs personal authentication with authentication account information that only the worker can know on the virtual currency conversion device (3) of the third party. The virtual currency conversion device (3) references the personal information storage means (3-5) to perform personal authentication and determines whether or not it is the actual person, and communicates the results to the virtual currency/point business operator (5).

Also, a determination is made of whether the monetary value for which a request was received from the worker for payment or conversion to virtual currency or points is within the balance stored in the balance storage means (3-2). When both items match, authorization for paying the wages is communicated to the payment terminal (5-1) of the virtual currency/point business operator (5).

The virtual currency/point business operator (5) makes a conversion request to the virtual currency conversion device (3). On the basis of the request, transfer slip information is created by the virtual currency conversion device (3), and from the wage payment amount of the worker kept in the bank account of the third party (3-7), the payment amount specified by the worker or the monetary value for which a request was made to convert to virtual currency or points is transferred from the account of the third party (3-7) to the virtual currency/point business operator (5).

As a result, the virtual currency/point business operator (5) converts the transferred monetary value to virtual currency. Also, in the case of points, the value is converted to points. Because of that, the worker is able to receive his or her own wages in virtual currency or points.

Also, when the worker wishes to receive cash, by selecting payment in cash, it is possible to receive cash at the window of a financial institution or the like.

The worker is also able to aggregate wages from various payment sources, to receive the aggregated wages in the form of virtual currency, points, or cash, and to use them for shopping and other occasions.

### Process Flow of Embodiment 2

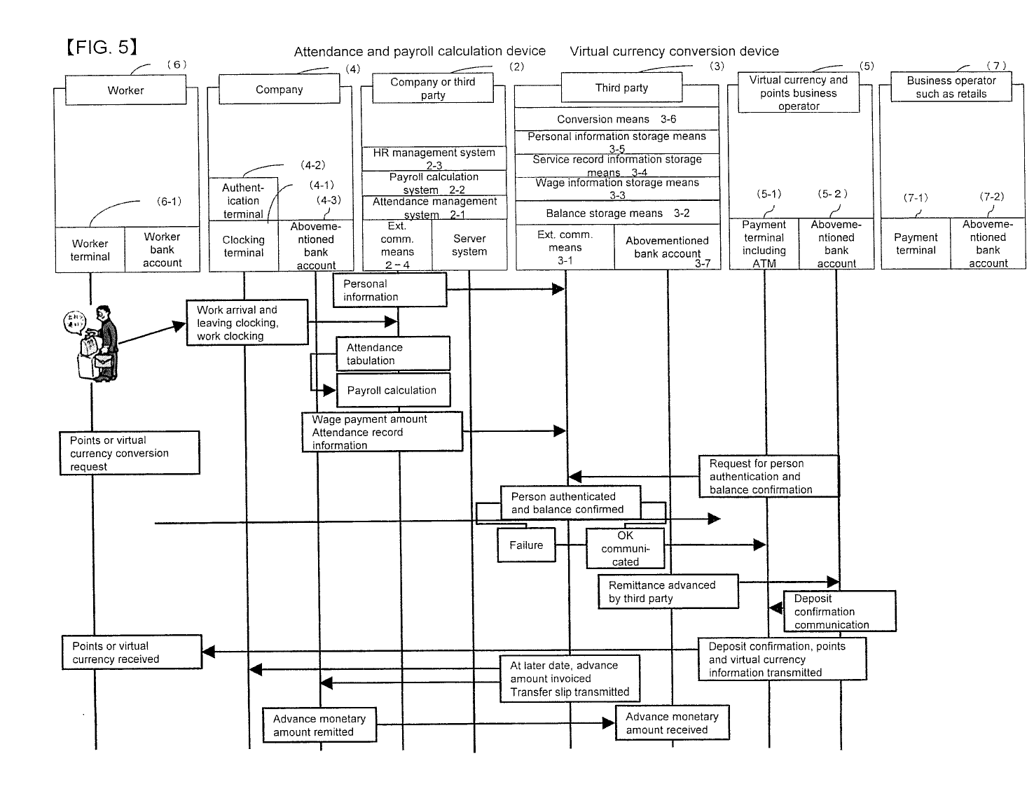

FIG. 5 shows a case of when initially the worker requests conversion of the wages to virtual currency or the like or when the worker requests for payment, the third party temporarily settles the wage payment in advance, instead of the company, and afterward invoices to the company, and collects the wage paid to the worker from the company. A description is omitted for the processes that are the same as those of the first embodiment noted above.

In this case, first, the worker uses the payment terminal (5-1) of the virtual currency/point business operator (5), and makes a request of the virtual currency/point business operator (5) for conversion to virtual currency. The operation can be carried out by the worker, but a representative can also do the operation.

The virtual currency/point business operator (5) performs personal authentication using authentication account information that only the worker can know on the virtual currency conversion device (3) of the third party. The virtual currency conversion device (3) references the personal information storage means to perform personal authentication, determines whether the person is the actual person, and sends a communication to the virtual currency/point business operator (5). At the same time, the virtual currency conversion device (3) transfers the payment amount or monetary value for which a request for conversion was made to the virtual currency/point business operator (5) from the third party bank account (3-7) instead of the worker. As a result, the virtual currency conversion device (3) converts to virtual currency the monetary value for which a request was made for conversion from the wages of the worker. When points are selected, the monetary value is converted to points. Also, when payment is selected directly, payment is made in cash.

Subsequently, the third party, which is the operator of the virtual currency conversion device (3), invoices the company (4) that is the employer of the worker and collects the amount that was paid in advance from wages. When collecting the amount, it is possible to demand a processing fee from the company (4).

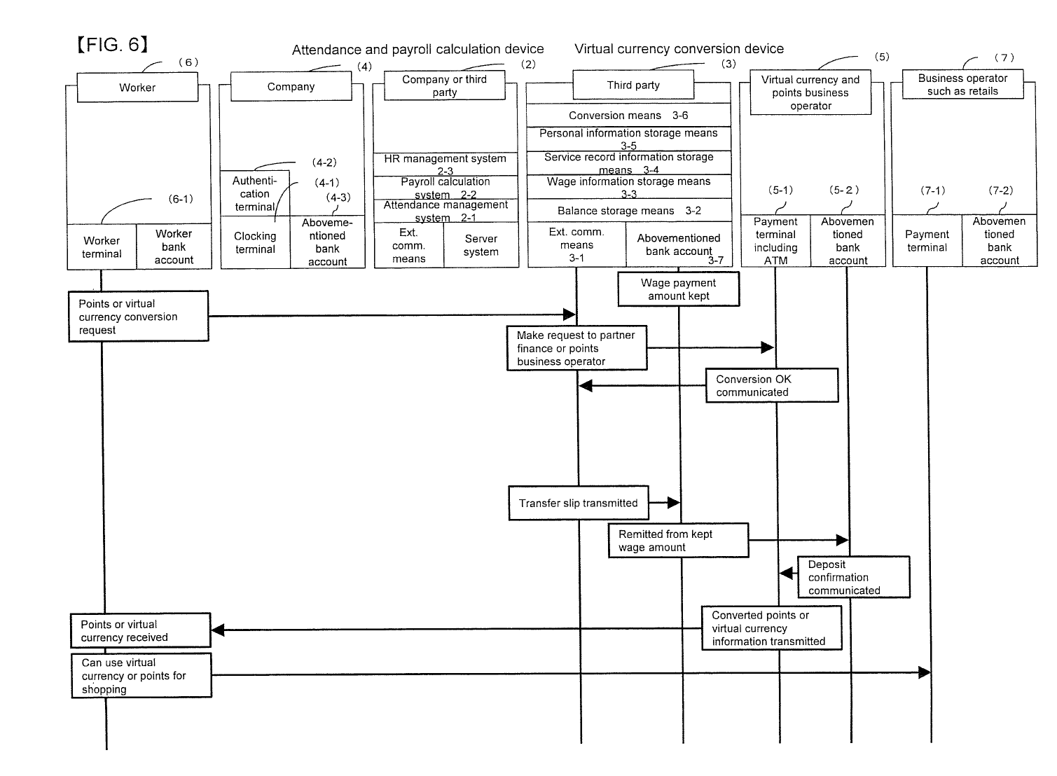

With FIG. 6, when the worker (6) has a worker terminal (6-1), the worker terminal (6-1) should be a device capable of communicating via a network, such as a “personal computer terminal,” a cell phone terminal, a personal digital assistant (PDA), a wearable terminal, configured to be capable of communicating with the internet or the like.

When there is an access through a network such as the internet to the virtual currency conversion device (3) operated by the third party from the worker terminal (6-1) of the worker (6), based on authentication account information that can only be known by the worker, the personal information storage means of the virtual currency conversion device (3) is referred to perform personal authentication.

If the results of determining whether the person is the actual person are successful, a communication is delivered to the virtual currency/point business operation (5) of the monetary value for which there is a request from the worker (6) for payment or conversion to virtual currency or points. Simultaneous with the conversion OK, from the wage payment amount of the worker (6) kept in the third party bank account (3-7), the payment amount specified from the worker (6) or the monetary value he wishes to convert to virtual currency or points is transferred to the virtual currency/point business operator (5).

As a result, the amount specified when there is a wish to convert to virtual currency is converted to virtual currency, and, when there is a wish to convert to points, is converted to points. Also, when there is a wish for payment, the worker (6) can directly receive a payment in cash.

The payment terminal (5-1) of the virtual currency/point business operator (5) and the virtual conversion device (3) of the third party are connected by a network such as the internet.

The worker (6) accesses to the virtual currency conversion device (3) through an external communication means of the virtual conversion device (3) using the payment terminal (5-1). With the virtual currency conversion device (3), the worker (6) is identified by the personal information storage means (3-5), and personal authentication is executed based on a personal authentication key of the worker (6).

Also, the virtual currency conversion device (3) refers to the balance in the balance storage means (3-2), in which the wage payment amount is recorded, confirms the payment amount requested by the worker or the amount to be converted to virtual currency or points, and together with the approval results communicates the payment amount requested by the worker (6) to the payment terminal (5-1) of the virtual currency/point business operator. When the worker approves payment or conversion in response to the corresponding communication from the payment terminal (5-1), the process is executed.

### Effect of the Embodiments

1. Even a worker who works with a company using a bank transfer system but does not have a bank account can receive cash.

2. Even a worker who works with a company using a bank transfer system but does not have a bank account can convert the wage payment amount to virtual currency or points that can be exchanged for the cost of clothing, food, and housing needed for living.

3. Even a worker who works with a company using a periodic wage payment system but does not have a bank account can receive compensation for work.

4. Even a worker who works with a company using a periodic wage payment system but does not have a bank account can convert the wage payment amount to virtual currency or points that can be exchanged for the cost of clothing, food, and housing needed for living.

5. A person who works with a company using a bank transfer system and who has a bank account can also convert the wage payment amount to virtual currency or points that can be exchanged for the cost of clothing, food, and housing needed for living.

6. A person who works with a company using a periodic wage payment system and who has a bank account can also convert the wage payment amount to virtual currency or points that can be exchanged for the cost of clothing, food, and housing needed for living.

### REFERENCE SIGNS LIST

1 Virtual currency conversion system
2 Attendance and payroll calculation device
3 Virtual currency conversion device
4-1 Clocking terminal
4-2 Authentication terminal
5-1 Payment terminal (of virtual currency/point business operator)
6-1 Worker terminal
7-1 Payment terminal (of business operator such as a retails)

1. A device configured so as to be capable of communicating with a payment terminal of a virtual currency/point business operator, possessed by a third party independent from a wage payment source, such as a company, and from workers, and used for paying a wage from the wage payment source to the workers as compensation for work, wherein the virtual currency conversion device is characterized in comprising:
personal information storage means for storing personal information of the workers;
wage information storage means for storing a wage payment amount to the workers that has been approved by the wage payment source;
balance storage means for recording the balance of the wage payment amount that can be converted to virtual currency or points; and
conversion means for receiving a request from the workers to convert a specified monetary value of the wage payment amount to virtual currency or points, determining whether the personal information stored in the personal information storage means matches the worker making the conversion request, determining whether the specified monetary value for which the conversion request was received is within the balance stored in the balance storage means, and, when both conditions are met, communicating that authorization is granted for wage payment to the wage terminal of the virtual currency/point business operator.

2. The virtual currency conversion device according to claim 1, wherein
the wage payment amount of those among the workers who do not have a bank account is temporarily transferred from a bank account of the company to a bank account of a virtual currency conversion device operator or a bank account specified by the virtual currency conversion device operator, and cash will be paid from the bank account to which the wage payment amount was transferred, the cash being paid via a payment system of a financial institution in response to a payment request by the worker.

3. The virtual currency conversion device according to claim 1, wherein:
a connection can be established with a plurality of payment source terminals;
wage information to the worker from the plurality of payment sources is stored in the wage information storage means; and
the conversion means pays the wage from any of the payment sources by communicating authorization of wage payment to the payment terminals of the virtual currency/point business operators.

4. The virtual currency conversion device according to claim 3, wherein
the conversion means aggregates wages from the plurality of payment sources, and pays the wages by communicating authorization of wage payment to the payment terminals of the virtual currency/point business operators.

5. The virtual currency conversion device according to claim 1, wherein
the balance stored in the balance storage means corresponds to the balance for the wage from the payment source previously kept by the operator of the virtual currency conversion device.

6. The virtual currency conversion device according to claim 1, wherein
information on the attendance of the worker and periodic wage payment information calculated based on the attendance records are stored in the wage information storage means; and
the balance stored in the balance storage means corresponds to the balance for which the operator of the virtual currency conversion device has made an advance for the wage amount to be paid to the worker by the payment source according to the periodic wage payment information.

7. The virtual currency conversion device according to claim 1, wherein
the wage information is the wages that are accrued in each working day.

8. A virtual currency conversion method performed by a computer that is: configured so as to be capable of communicating with a payment terminal of a virtual currency/point business operator, possessed by a third party independent from a wage payment source, such as a company and from a worker, and intended for paying a wage from the payment source to the worker as compensation for work, the computer comprising:
personal information storage means for storing personal information of the worker;
wage information storage means for storing the amount of a wage paid to the worker and approved by the payment source; and
balance storage means for recording the balance of the wage payment amount that can be converted to virtual currency or points; wherein the method is characterized in comprising:
a process for receiving a request from the worker to convert a specified monetary value of the wage payment amount to virtual currency or points;
a process for determining whether the personal information stored in the personal information storage means matches the worker making the conversion request;
a process for determining whether the specified monetary value for which the conversion request was received is within the balance stored in the balance storage means; and
a process for communicating authorization for wage payment to the payment terminal of the virtual currency/point business operator when both conditions are met.

9. A non-transitory computer-readable medium in which a computer program is embodied, wherein the computer is: configured so as to be capable of communicating with a payment terminal of a virtual currency/point business operator; possessed by a third party independent from a wage payment source, such as a company and from a worker; and, in order for wages to be paid from the payment source to the worker as compensation for work, provided with:
personal information storage means for storing personal information of the worker;
wage information storage means for storing the amount of a wage paid to the worker and approved by the payment source; and
balance storage means for recording the balance of the wage payment amount that can be converted to virtual currency or points; wherein the computer program executes:
a process for receiving a request from the worker to convert a specified monetary value of the wage payment amount to virtual currency or points;
a process for determining whether the personal information stored in the personal information storage means matches the worker who makes the conversion request;
a process for determining whether the specified monetary value for which the conversion request was received is within the balance stored in the balance storage means; and
a process for communicating authorization for wage payment to the payment terminal of the virtual currency/point business operator when both conditions are met.

10. The virtual currency conversion device according to claim 4, wherein
the balance stored in the balance storage means corresponds to the balance for the wage from the payment source previously kept by the operator of the virtual currency conversion device.

11. The virtual currency conversion device according to claim 4, wherein
information on the attendance of the worker and periodic wage payment information calculated based on the attendance records are stored in the wage information storage means; and
the balance stored in the balance storage means corresponds to the balance for which the operator of the virtual currency conversion device has made an advance for the wage amount to be paid to the worker by the payment source according to the periodic wage payment information.

12. The virtual currency conversion device according to claim 10, wherein
the wage information is the wages that are accrued in each working day.

13. The virtual currency conversion device according to claim 11, wherein
the wage information is the wages that are accrued in each working day.

14. The virtual currency conversion device according to claim 2, wherein:
a connection can be established with a plurality of payment source terminals;
wage information to the worker from the plurality of payment sources is stored in the wage information storage means; and
the conversion means pays the wage from any of the payment sources by communicating authorization of wage payment to the payment terminals of the virtual currency/point business operators.

15. The virtual currency conversion device according to claim 14, wherein
the conversion means aggregates wages from the plurality of payment sources, and pays the wages by communicating authorization of wage payment to the payment terminals of the virtual currency/point business operators.

16. The virtual currency conversion device according to claim 15, wherein
the balance stored in the balance storage means corresponds to the balance for the wage from the payment source previously kept by the operator of the virtual currency conversion device.

17. The virtual currency conversion device according to claim 15, wherein
information on the attendance of the worker and periodic wage payment information calculated based on the attendance records are stored in the wage information storage means; and
the balance stored in the balance storage means corresponds to the balance for which the operator of the virtual currency conversion device has made an advance for the wage amount to be paid to the worker by the payment source according to the periodic wage payment information.

18. The virtual currency conversion device according to claim 16, wherein
the wage information is the wages that are accrued in each working day.

19. The virtual currency conversion device according to claim 17, wherein
the wage information is the wages that are accrued in each working day.
